(19) United States
(12) Patent Application Publication
(10) Pub. No.: US 2017/0148021 A1
(43) Pub. Date: May 25, 2017

(54) HOMOGENIZATION OF ONLINE FLOWS AND BACKEND PROCESSES

(71) Applicant: The Western Union Company, Englewood, CO (US)

(72) Inventors: Daniel Goldstein, San Francisco, CA (US); Abhishek Banerjee, San Francisco, CA (US); Marc Elbirt, San Francisco, CA (US); Seshu Pandey, San Francisco, CA (US); Kevin Lai, San Francisco, CA (US); Sanjay Saraf, San Jose, CA (US)

(73) Assignee: The Western Union Company, Englewood, CO (US)

(21) Appl. No.: 15/355,632

(22) Filed: Nov. 18, 2016

Related U.S. Application Data
(60) Provisional application No. 62/257,233, filed on Nov. 19, 2015.

(51) Int. Cl. G06Q 20/40; H04L 29/06; G06Q 20/10; H04L 12/66

(52) U.S. Cl. CPC G06Q 20/401; H04L 12/66; H04L 67/42; H04L 63/04; H04L 63/12; G06Q 20/10

(57) ABSTRACT

Techniques are disclosed for providing secure transaction functionality using a centralized digital gateway configured to process transactions of various types, using different transaction processing entities, within a single processing flow. The digital gateway may implement rules and logic to optimize transaction processing costs. Additionally, transaction authorization, various types of transaction analyses, and transaction processing and dispatch processes may be performed in parallel, as directed by the implemented rules and logic, in order to optimize transaction processing costs and processing speeds. Further, digital gateway may be configured to normalize transaction request data across different transaction types, allowing the transaction request data to be transmitted in a uniform manner to related back-end systems, partner systems, and transaction processors.

### CROSS-REFERENCE TO RELATED APPLICATIONS

The present application is a non-provisional of and claims priority to U.S. Provisional Patent Application No. 62/257,233, filed Nov. 19, 2015, entitled “SYSTEMS AND METHODS FOR HOMOGENIZING ONLINE FLOWS AND BACKEND PROCESSES,” the entire contents of which are incorporated herein by reference for all purposes.

### BACKGROUND

Field of the Invention

The present invention relates generally to receiving and processing secure transfers between devices at different locations or domains within electronic transfer networks.

Description of the Related Art

Within electronic data transfer networks, one or more central transfer servers along with various intermediary computing infrastructure and communication networks may be used to initiate and perform secure transfers between sender devices and receiver devices. In some cases, sender devices and receiver devices for a requested transfer may operate at separate locations or domains with a larger transfer system, and thus may have different networks and different subsets of available resources may be available to the different devices within the requested transaction. Central gateways and transfer servers, and other computing systems may determine and assign resources for performing requested transfers, for example, based on credentials of senders and the sender devices initiating the requested transfers, and based on characteristics of requested transfers.

### SUMMARY

Aspects described herein for providing secure transaction functionality using a centralized digital gateway configured to process transactions of various types, using different transaction processing entities, within a single processing flow. The digital gateway may implement rules and logic to optimize transaction processing costs. Additionally, transaction authorization, various types of transaction analyses, and transaction processing and dispatch processes may be performed in parallel, as directed by the implemented rules and logic, in order to optimize transaction processing costs and processing speeds. Further, digital gateway may be configured to normalize transaction request data across different transaction types, allowing the transaction request data to be transmitted in a uniform manner to related back-end systems, partner systems, and transaction processors.

In certain embodiments, one or more servers of a digital gateway for processing transaction requests may be configured to receive transaction requests from client devices. The digital gateway may determine one or more particular transaction processors to process the transaction requests, based on the transaction request data and/or factors relating to the available transaction processors. The digital gateway may transmit authorization messages to the corresponding transaction processors, and also may initiate various analyses on the transaction request to be performed concurrently with the authorization process by the transaction processors. Additionally, the digital gateway may determine corresponding orders and times for transaction capture, processing, and/or dispatch based on the analyses and other factors, and may initiate the transaction processing and transaction dispatching at the determined times.

In accordance with additional techniques described herein, transaction requests received by the digital gateway from client devices may identify transaction amounts/values, users, associated geographic locations, and/or transaction types (e.g., payment types). However, in some embodiments, transaction requests might not specify particular transaction processors, and the digital gateway may select transaction processors and route requests to the selected transaction processors, such that the selected transaction processors need not be provided or revealed to the client devices. Additionally, in certain embodiments, the rules and logic implemented by the digital gateway may result in a determination to capture, initiate processing, and/or dispatch (or remit) outputs of the transactions at different times based on transaction risk analyses, compliance analyses, etc. Further, in some cases, transaction capturing, transaction processing, and/or transaction dispatching processes may be initiated via transaction-specific messages from the digital gateway to related systems, rather than via pre-scheduled batch processing.

### BRIEF DESCRIPTION OF THE DRAWINGS

FIG. 1 is a block diagram illustrating an example of an electronic data transfer network, according to one or more embodiments of the disclosure.

FIG. 2 is a block diagram illustrating various components and features of an example transaction client device, according to one or more embodiments of the disclosure.

FIG. 3 is a block diagram illustrating a computer server and computing environment within an electronic data transfer network, according to one or more embodiments of the disclosure.

FIG. 4 is a block diagram illustrating an embodiment of one or more data store servers within an electronic data transfer network, according to one or more embodiments of the disclosure.

FIG. 5 is a block diagram illustrating an embodiment of one or more content management servers within an electronic data transfer network, according to one or more embodiments of the disclosure.

FIG. 6 is a block diagram illustrating the physical and logical components of a special-purpose computing device within an electronic data transfer network, according to one or more embodiments of the disclosure.

FIG. 7 is a block diagram illustrating an example transaction processing system including a digital gateway, related back-end systems, transaction processing systems, and client devices, according to one or more embodiments of the disclosure.

FIG. 8 is a block diagram illustrating another example system for processing eMerchant transactions, including a digital gateway, related front-end and back-end systems, core systems, and partner systems, according to one or more embodiments of the disclosure.

FIG. 9 is an example swim lane diagram illustrating an example process of processing transactions using a digital gateway and related back-end systems, according to one or more embodiments of the disclosure.

FIG. 10 is a flow diagram illustrating an example process of updating a transaction system to a new transaction processor, according to one or more embodiments of the disclosure.

FIG. 11 is a block diagram illustrating another example system for processing transactions, including a digital gateway, related back-end systems, transaction processing systems, and client devices, according to one or more embodiments of the disclosure.

FIG. 12 is a flow diagram illustrating an example process of processing transactions using a digital gateway and related back-end systems, according to one or more embodiments of the disclosure.

It is noted that any of the elements and/or steps provided in the block diagrams, flow diagrams, method diagrams, and other illustrations of the figures may be optional, replaced, and/or include additional components, such as combined and/or replaced with other elements and/or steps from other figures and text provided herein. Various embodiments of the present invention are discussed below, and various combinations or modifications thereof may be contemplated.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Various techniques (e.g., systems, methods, computer-program products tangibly embodied in a non-transitory computer-readable storage medium, etc.) are described herein for providing secure transaction functionality using a centralized digital gateway configured to process transactions of various types, using various transaction processing entities, within a single flow. The digital gateway may implement rules and logic to optimize transaction processing costs. Additionally, transaction authorization, various types of transaction analyses, and transaction processing and dispatch processes may be performed in parallel, as directed by the implemented rules and logic, in order to optimize transaction processing costs and processing speeds. Further, digital gateway may be configured to normalize transaction request data across different transaction types, allowing the transaction request data to be transmitted in a uniform manner to related back-end systems, partner systems, and transaction processors.

In certain embodiments, one or more servers of a digital gateway for processing transaction requests may be configured to receive transaction requests from client devices. The digital gateway may determine one or more particular transaction processors to process the transaction requests, based on the transaction request data and/or factors relating to the available transaction processors. The digital gateway may transmit authorization messages to the corresponding transaction processors, and also may initiate various analyses on the transaction request to be performed concurrently with the authorization process by the transaction processors. Additionally, the digital gateway may determine corresponding orders and times for transaction capture, processing, and/or dispatch based on the analyses and other factors, and may initiate the transaction processing and transaction dispatching at the determined times.

In accordance with additional techniques described herein, transaction requests received by the digital gateway from client devices may identify transaction amounts/values, users, associated geographic locations, and/or transaction types (e.g., payment types). However, in some embodiments, transaction requests might not specify particular transaction processors, and the digital gateway may select transaction processors and route requests to the selected transaction processors, such that the selected transaction processors need not be provided or revealed to the client devices. Additionally, in certain embodiments, the rules and logic implemented by the digital gateway may result in a determination to capture, initiate processing, and/or dispatch (or remit) outputs of the transactions at different times based on transaction risk analyses, compliance analyses, etc. Further, in some cases, transaction capturing, transaction processing, and/or transaction dispatching processes may be initiated via transaction-specific messages from the digital gateway to related systems, rather than via pre-scheduled batch processing.

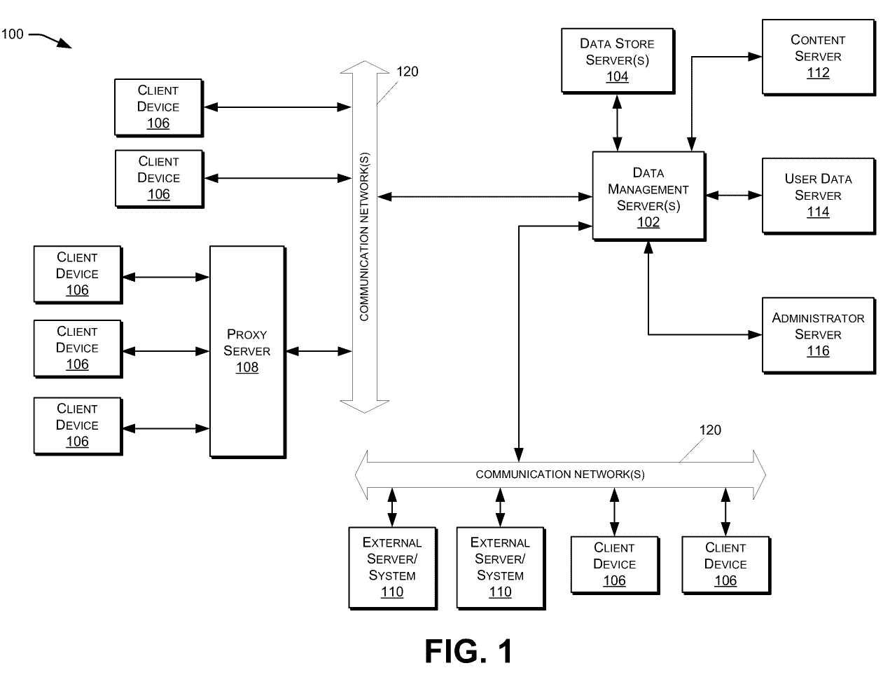

With reference now to FIG. 1, a block diagram is shown illustrating various components of an electronic transfer network 100 which implements and supports certain embodiments and features described herein. As discussed below in more detail, various embodiments of electronic transfer networks 100 may be implemented and configured to process secure transactions using a digital gateway (e.g., data management server 102) configured to operate as a centralized system to execute a single flow for processing transactions of various types and using various transaction processing entities. In various embodiments, digital gateways described herein may implement rule-based routing mechanisms for optimizing transaction processing costs, in which the rules support routing to an optimal processor and may include initiating concurrent transaction analyses. Further digital gateways described herein may be configured to normalize transaction data associated with various transaction types, allowing the transaction data to be transmitted in a uniform manner to related back-end systems.

In some embodiments, the various computing devices and systems shown in FIG. 1 may correspond to different physical or virtual domains/regions, for instance, different geographic areas within different jurisdictions, different data centers, different networks, different computing infrastructures, etc. As described herein, secure transactions (or secure transfers) may include transfers of various different types of data items (e.g., files, database records, media or other content resources, etc.), as well as other secure data transactions or other interactions between a sender and receiver devices/servers. In some embodiments, the electronic transfer network 100 may be configured to operate as a value transfer system by which users at client devices 106 may initiate value transfers to users at other client devices 106. In such cases, management servers 102 and/or external systems 110 may correspond to secure systems operated by financial institutions or other entities, by which sender and receiver credentials and value transfer requests may be received and analyzed, and value-based transactions may be authorized and performed.

Thus, in various embodiments, electronic transfer network 100 may be configured to support and perform transfers of various currency types, including traditional and/or digital currencies, centralized and/or de-centralized currencies, cryptocurrencies, and any other medium of exchange (e.g., credit, gift cards or certificates, points in a user point system, etc.), between client devices 106 and/or external systems 110 in different areas, regions, or jurisdictions. In other embodiments, the electronic transfer network 100 may be configured to perform other types of multi-party data transfers and/or secure transactions, such as transfers of data items including secure files, records, and/or content resources, between client devices 106 and other client devices 106, management servers 102 and/or external systems 110. For such transfers, the endpoint systems may be operating in the same location, using the same communication networks 120, and/or using the same computing hardware and software infrastructure, or may operate in different locations, on different networks, and/or in different datacenters, etc. Data management servers 102 and related servers (e.g., 104, 108, 112, 114, 116, etc.) in some embodiments, may correspond to authentication systems, data access/permission systems, subscription monitor systems, network access providers, and/or any other servers that may be used to monitor, permit/deny access, and/or enable data transfers. In still other embodiments, network 100 may be implemented as part of interactive gaming systems, educational and profession training systems, and/or social network systems, to enable the transfer of certain data or values (e.g., points, credits, resources, etc.) between users on different systems and/or in different locations.

As shown in FIG. 1, electronic transfer network 100 may include one or more data management servers 102. Data management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Data management servers 102 may include one or more server farms, clusters, or any other appropriate arrangement and/or combination or computer servers. Data management servers 102 may act according to stored instructions located in a memory subsystem of the servers 102, and may run an operating system, including any commercially available server operating system and/or any other operating systems discussed herein.

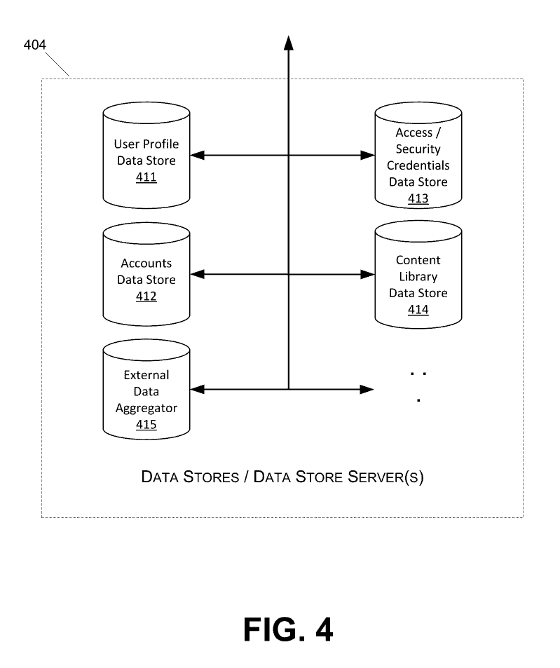

The electronic transfer network 100 may include one or more data store servers 104, such as database servers and file-based storage systems. Data stores 104 may comprise stored data relevant to the functions of the electronic transfer network 100. Illustrative examples of data stores 104 that may be maintained in certain embodiments of the electronic transfer network 100 are described below in reference to FIG. 4. In some embodiments, multiple data stores may reside on a single server 104, either using the same storage components of server 104 or using different physical storage components to assure data security and integrity between data stores. In other embodiments, each data store may have a separate dedicated data store server 104.

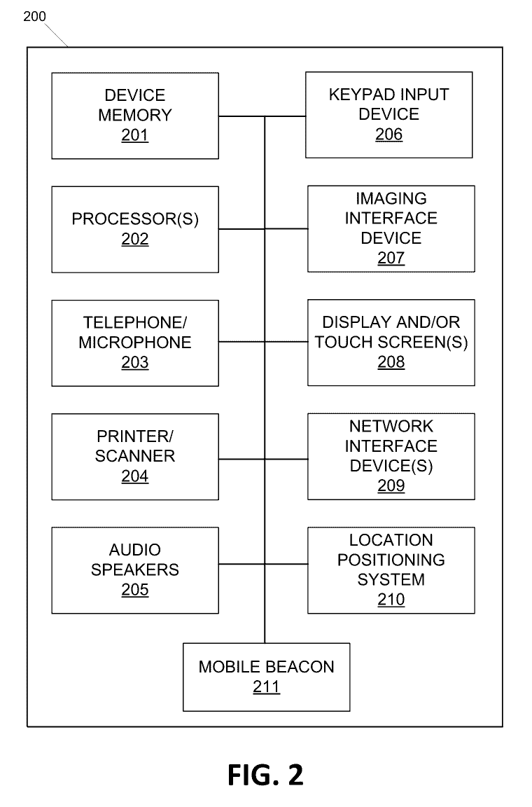

Electronic transfer network 100 also may include one or more client devices 106. Client devices 106 may display data received via the electronic transfer network 100, and may support various types of user interactions with the data. Client devices 106 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other client devices 106 may be general purpose personal computers or special-purpose computing devices including, by way of example, personal computers, laptop computers, workstation computers, projection devices, and interactive room display systems. Additionally, client devices 106 may be any other electronic devices, such as thin-client computers, Internet-enabled gaming systems, business or home appliances, and/or personal messaging devices, capable of communicating over network(s) 120. In some embodiments, one or more client devices 106 may include digital kiosk devices such as point-of-sale terminals, value transfer terminals, and/or digital advertising or display devices, including some or all of the features described below in reference to FIG. 2.

In different contexts of electronic transfer networks 100, client devices 106 may correspond to different types of specialized devices, for example, employee devices and presentation devices in a company network, gaming devices in a gaming network, networked point-of-sale terminals or digital advertising terminals in a retail network, etc. In some embodiments, client devices 106 may operate in the same physical location, such as the conference room or same retail store location. In such cases, the devices 106 may contain components that support direct communications with other nearby devices 106, such as a wireless transceivers and wireless communications interfaces, Ethernet sockets or other Local Area Network (LAN) interfaces, etc. In other implementations, the client devices 106 need not be used at the same physical location, but may be used in remote geographic locations in which each client device 106 may use security features and/or specialized hardware (e.g., hardware-accelerated SSL and HTTPS, WS-Security, firewalls, etc.) to communicate with the data management server 102 and/or other remotely located client devices 106. Additionally, different client devices 106 may be assigned different designated roles, such as sender devices, receiver devices, administrator devices, or the like, and in such cases the different devices may be provided with additional hardware and/or software components to provide content and support user capabilities not available to the other devices.

The electronic transfer network 100 also may include one or more proxy servers 108 configured to operate between a set of related client devices 106 and the back-end server(s) 102. In some cases, proxy server 108 may maintain private user information for client devices 106 interacting with applications or services hosted on other servers. For example, the proxy server 108 may be used to maintain private data of a user within one jurisdiction even though the user is accessing an application hosted on a server (e.g., the data management server 102) located outside the jurisdiction. In such cases, the proxy server 108 may intercept communications between multiple different client devices 106 and/or other devices that may include private user information. The proxy server 108 may create a token or identifier that does not disclose the private information and may use the token or identifier when communicating with the other servers and systems, instead of using the user's private information.

The electronic transfer network 100 also may include one or more external servers/systems 110 configured to connect to the back-end server(s) 102 through various communication networks 120 and/or through proxy servers 108. External servers/systems 110 may include some or all of the same physical and logical components as the data management server(s) 102, and may be configured to provide various data sources and/or services to the other components of the electronic transfer network 100.

As illustrated in FIG. 1, the data management server 102 may be in communication with one or more additional servers, such as a content server 112, a user data server 112, and/or an administrator server 116. Each of these servers may include some or all of the same physical and logical components as the data management server(s) 102, and in some cases, the hardware and software components of these servers 112-116 may be incorporated into the data management server(s) 102, rather than being implemented as separate computer servers.

Content server 112 may include hardware and software components to generate, store, and maintain the content resources for distribution to client devices 106 and other devices in the network 100. For example, in electronic transfer networks 100 used for professional training and educational purposes, content server 112 may include data stores of training materials, presentations, interactive programs and simulations, and various training interfaces that correspond to different materials and/or different types of user devices 106. In content electronic transfer networks 100 used for distribution of media content, advertising, and the like, a content server 112 may include media and advertising content files.

User data server 114 may include hardware and software components that store and process data for multiple users relating to each user's activities and usage of the electronic transfer network 100. For example, the data management server 102 may record and track each user's system usage, including their client device 106, data accessed and transferred, and interactions with other client devices 106. This data may be stored and processed by the user data server 114, to support user tracking and analysis features. For instance, in business training contexts, the user data server 114 may store and analyze each user's training materials viewed, courses completed, interactions, and the like. In the context of advertising, media distribution, and interactive gaming, the user data server 114 may store and process resource access data for multiple users (e.g., transactions initiated, sent, and received, data files accessed, access times, data usage amounts, user histories, user devices and device types, etc.).

Administrator server 116 may include hardware and software components to initiate various administrative functions at the data management server 102 and other components within the content distribution network 100. For example, the administrator server 116 may monitor device status and performance for the various servers, data stores, and/or client devices 106 in the electronic transfer network 100. When necessary, the administrator server 116 may add or remove devices from the network 100, and perform device maintenance such as providing software updates to the devices in the network 100. Various administrative tools on the administrator server 116 may allow authorized users to set user access permissions to various data resources, monitor resource usage by users and devices 106, and perform analyses and generate reports on specific network users and/or devices (e.g., resource usage tracking reports, training evaluations, etc.).

The electronic transfer network 100 may include one or more communication networks 120. Although two networks 120 are identified in FIG. 1, the electronic transfer network 100 may include any number of different communication networks between any of the computer servers and devices shown in FIG. 1 and/or other devices described herein. Communication networks 120 may enable communication between the various computing devices, servers, and other components of the electronic transfer network 100. As discussed below, various implementations of electronic transfer networks 100 may employ different types of networks 120, for example, computer networks, telecommunications networks, wireless networks, and/or any combination of these and/or other networks.

As noted above, in certain embodiments, electronic transfer network 100 may be a cryptocurrency network or other network using encryption protocols and techniques for performing transfers of cryptocurrency and/or other alternative digital currencies. Illustrative and non-limiting examples of such cryptocurrency networks may include a bitcoin peer-to-peer (P2P) payment network, a Litecoin network, a Peercoin network, and various other private digital cryptocurrency networks. The various computing devices and servers in such cryptocurrency networks 100, including client devices 106, management servers 102, and/or external systems 110, may be configured to perform cryptocurrency transfers as senders and/or receivers. For example, a client device 106 may securely store a private cryptographic key associated with a cryptocurrency account of a user, and may use specialized client software (e.g., cryptocurrency wallet application) to generate digital cryptographic signatures using the private cryptographic key and data identifying the details of the requested cryptocurrency transfer. In some cases, the cryptocurrency client application may execute a cryptographic hash function to generate a hash value signature based on the private key value associated with the cryptocurrency account. Recipient client devices 106, as well as other servers/systems in the network 100, may use the public key of the sender to decrypt the cryptographic signature and verify the authenticity of the requested cryptocurrency transfer. Some or all of the client devices 106, servers 102, and/or external systems 110 may use databases or other secure storage to independently maintain and update electronic ledgers for tracking the current balances associated with cryptocurrency accounts.

In some embodiments, certain computing devices and servers in a cryptocurrency network 100 may function as miner systems that are configured to perform complex mathematical operations in order to produce new cryptocurrency. Thus, various client devices 106, servers 102, and/or external systems 110 may be implemented as cryptocurrency miners. In some cases, these devices/systems may include specialized hardware and software designed for cryptocurrency mining, such as application-specific integrated circuits (ASICs) that are specifically designed and configured for cryptocurrency mining and/or specialized cryptocurrency mining software. In some cases, specialized cryptocurrency mining software may be used to allow collaboration between multiple different devices/systems which may function as a mining pool.

In some embodiments, various computing devices and servers in a cryptocurrency network 100 may be configured to collaboratively generate and store universal public ledgers and/or transaction chains for the cryptocurrency network 100. For example, computing devices and systems within the cryptocurrency network 100 may be configured to retrieve individual cryptocurrency transactions from a pool and resolve the transactions by solving associated mathematical problems, such as cryptographic hashes. After the problem is solved, the associated cryptocurrency transaction may be added to a universal transaction chain which is shared by other devices and systems of the cryptocurrency network 100. Each device/system in the cryptocurrency network 100 may independent maintain a copy of the transaction chain, and may periodically (or upon request from other systems) share their copy of the transaction chain in order to synchronize and reconcile different versions.

In some embodiments, a transaction chain for a cryptocurrency system/network may be stored in a distributed database by multiple different data nodes at different devices/servers within the network 100. For example, blockchain technology may be used to implement a decentralized distributed database which may be hosted by a combination of client devices 106, data management servers 102, and/or external systems 110. The blockchain (or other decentralized storage system) may store a distributed electronic ledger and/or universal transaction chain for the cryptocurrency network 100. The blockchain may be accessed by individual client software (e.g., wallet applications) of client devices 106, which may propose a cryptocurrency value transfer to be added to the blockchain. After analyzing and authorizing the requested transfer (e.g., by confirming that there is sufficient cryptocurrency value in the sender's account), a miner node within the cryptocurrency network 100 may bundle the transfer with other transactions to create a new block to be added to the blockchain. In some cases, adding blocks to the blockchain may involve miner nodes repeatedly executing cryptographic hash functions, ensuring that the blockchain cannot be tampered with by any malicious systems within the network 100.

As noted above, the client devices 106 in the electronic transfer network 100 may include various mobile devices, such as smartphones, tablet computers, personal digital assistants, wearable computing devices, bodily implanted communication devices, vehicle-based devices, etc. Within an electronic transfer network 100, mobile devices 106 may be configured to support mobile payment and/or mobile money transfer functionality. Such mobile devices 106 may initiate and receive communications via the Internet, e-mail, short message service (SMS), Bluetooth®, mobile radio-frequency identification (M-RFID), near-field communication (NFC) and/or various other communication protocols. In some cases, mobile devices 106 may execute a mobile wallet application to store user data and support secure data and/or value transfers via various different techniques, for example, SMS-based transactional payments, direct mobile billing, Web Application Protocol mobile payments, and NFC-based payments.

In some examples, the electronic transfer network 100 shown in FIG. 1 may correspond to an interactive user platform, such as a social networking platform, messaging platform, and/or gaming platform. In such cases, an electronic transfer technology platform may be integrated within the social networking, messaging and/or gaming platform 100, in order to provide interactive users with the capabilities to perform quick and convenient value transfers with other users anywhere in the world. Such embodiments may apply to various different collaborative user platforms and applications, including social media applications, email applications, chat and messaging applications, online gaming applications, and the like. These applications may be executed on client devices 106 and may transmit communications to and/or establish communication sessions with corresponding applications on other client devices 106 and/or external systems 110. In some embodiments, the secure data and/or value transfer capabilities of one or more transfer services providers may be embedded into various collaborative user platforms. For example, from within a social networking or messaging application running on client device 106, a user may be able to request and fund value transfers utilizing a debit card, credit card, or bank account, and easily direct the funds to another user on the same collaborative platform, or to retail agent location and/or to a mobile wallet or bank account. Integration of secure value transfer technologies within social networking applications, messaging applications, and the like, may provide a cross-border platform for transfer services that enables pay-in and pay-out capabilities that leverage technology, foreign exchange conversion, data management, as well as regulatory, compliance and anti-money laundering (AML) infrastructure of the transfer service provider, to expedite efficient and timely transfers. In such cases, the technology platform used to support secure data and/or value transfers within the network 100 may be accessible to messaging, social, and other digital networks, and may offer a suite of APIs built on a highly scalable infrastructure, enabling fast deployment of domestic and cross-border remittance capabilities.

Referring now to FIG. 2, a simplified block diagram is illustrating showing a digital kiosk device 206. In some embodiments, digital kiosk devices 206 may be another example of client devices 106. The digital kiosk device 206 may be implemented, for example, as a kiosk in a retail store, a value transfer terminal for performing value transfers (e.g., transfers of money and other assets, submitting payments to payees, etc.), a point-of-sale terminal, an electronic advertising system, and/or other various electronic display systems. The digital kiosk device 206 may be operated by a user (e.g., customer, shopper), and/or by agent, employee, or representative of a business providing or operating the kiosk 206. In various embodiments, the digital kiosk device 206 may include one or more of: a memory system 210, a processing unit 211, a telephone/microphone I/O component system 212, a printer/scanner I/O component system 213, an audio speaker system 214, a keypad input device 215, an imaging interface device 216, one or more digital display screens 217, one or more network interface devices 218 (e.g., network interface controllers, RF transceivers, etc.), and a digital positioning system 219 (e.g., Global Positioning System (GPS) receiver device). In various embodiments, digital kiosk devices 206 may include a touch screen that functions as the display screen 217 and/or the keypad 215. The keypad 215 may instead be any device that accepts user input, such as a trackball, mouse, or joystick. The imaging interface device 216 may serve to allow the digital kiosk device 206 to communicate with an imaging device. Alternatively, an imaging device may be directly incorporated into the digital kiosk device 206. Speakers 214 may be any audio output device. The printer 213 may be used to provide the user a receipt, point-of-sale information (e.g., product information, order confirmation, etc.), coupon, advertisement, or other information to be taken with the user, and scanner 213 may be used to scan a QR Code or barcode identifying a user or transaction, transfer request, user identification card, coupon, or the like. In some embodiments, a telephone/microphone 212 may be used in conjunction with speakers 214 to interact with the digital kiosk device 206, or a remotely located user (e.g., counterpart user in a transaction, customer representative, etc.) when performing a transfer or requesting information. Digital kiosk devices 206 may include various different types of digital position systems 219 (or geo-location systems 219), such as a Global Positioning System (GPS) receiver, so that kiosk location data may be collected and returned to data management servers 102 and/or other client devices 106. In some cases, such kiosk location data may be used to determine which content a specific digital kiosk device 206 is permitted to receive (e.g., based on domain/jurisdiction), and also may be used to determine factors such as language, data availability, network availability, product availability, and the like.

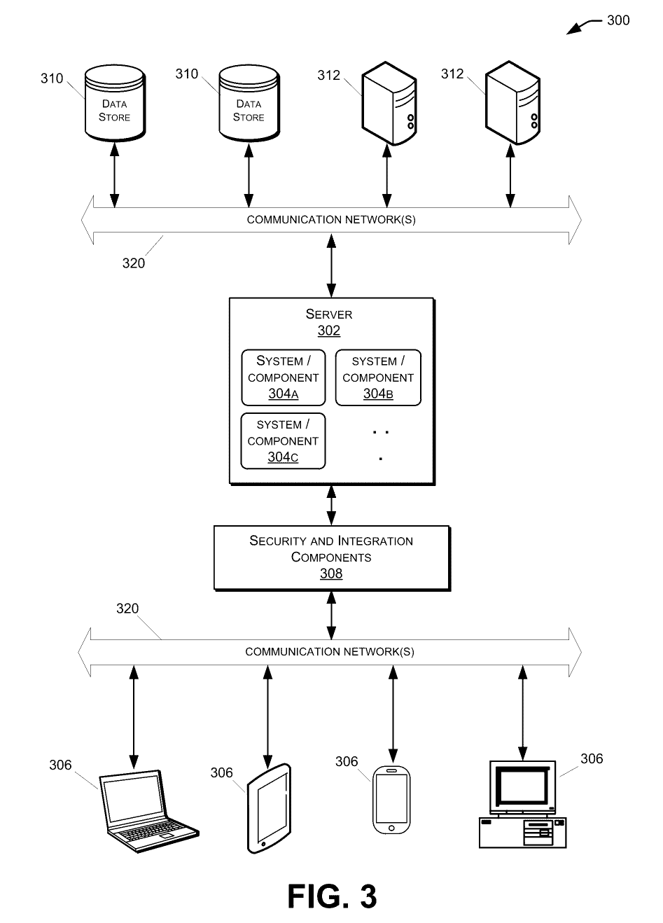

With reference to FIG. 3, an illustrative distributed computing environment 300 is shown including a computer server 302, four client computing devices 306, and other components that may implement certain embodiments and features described herein. In some embodiments, the server 302 may correspond to the data management server 102 discussed above in FIG. 1, and the client computing devices 306 may correspond to the client devices 106 and/or 206. However, the computing environment 300 illustrated in FIG. 3 also may correspond to any other combination of devices and servers configured to implement a client-server model or other distributed computing architecture.

Client devices 306 may be configured to receive and execute client applications over one or more networks 320. Such client applications may be web browser based applications and/or standalone software applications, such as mobile device applications. Server 302 may be communicatively coupled with the client devices 306 via one or more communication networks 220. Client devices 306 may receive client applications from server 302 or from other application providers (e.g., public or private application stores). Server 302 may be configured to run one or more server software applications or services, for example, web-based or cloud-based services, to support content distribution and interaction with client devices 306. Users operating client devices 306 may in turn utilize one or more client applications (e.g., virtual client applications) to interact with server 302 to utilize the services provided by these components.

Various different subsystems and/or components 304 may be implemented on server 302. Users operating the client devices 306 may initiate one or more client applications to use services provided by these subsystems and components. The subsystems and components within the server 302 and client devices 306 may be implemented in hardware, firmware, software, or combinations thereof. Various different system configurations are possible in different distributed computing systems 300 and electronic transfer networks 100. The embodiment shown in FIG. 3 is thus one example of a distributed computing system and is not intended to be limiting.

Although exemplary computing environment 300 is shown with four client computing devices 306, any number of client computing devices may be supported. Such client 306 may include digital kiosk devices including some or all of the features described below in reference to FIG. 2. Other devices, such as specialized sensor devices, etc., may interact with client devices 306 and/or server 302.

As shown in FIG. 3, various security and integration components 308 may be used to send and manage communications between the server 302 and user devices 306 over one or more communication networks 320. The security and integration components 308 may include separate servers, such as web servers and/or authentication servers, and/or specialized networking components, such as firewalls, routers, gateways, load balancers, and the like. In some cases, the security and integration components 308 may correspond to a set of dedicated hardware and/or software operating at the same physical location and under the control of same entities as server 302. For example, components 308 may include one or more dedicated web servers and network hardware in a datacenter or a cloud infrastructure. In other examples, the security and integration components 308 may correspond to separate hardware and software components which may be operated at a separate physical location and/or by a separate entity.

Security and integration components 308 may implement various security features for data transmission and storage, such as authenticating users and restricting access to unknown or unauthorized users. In various implementations, security and integration components 308 may provide, for example, a file-based integration scheme or a service-based integration scheme for transmitting data between the various devices in the electronic transfer network 100. Security and integration components 308 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 308 and/or elsewhere within the electronic transfer network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 302 and client devices 306. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 308 may include specialized hardware for providing secure web services. For example, security and integration components 308 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 320 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 320 may be local area networks (LAN), such as one based on Ethernet, Token-Ring and/or the like. Network(s) 320 also may be wide-area networks, such as the Internet. Networks 320 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 320.

Computing environment 300 also may include one or more data stores 310 and/or back-end servers 312. In certain examples, the data stores 310 may correspond to data store server(s) 104 discussed above in FIG. 1, and back-end servers 312 may correspond to the various back-end servers 110-116. Data stores 310 and servers 312 may reside in the same datacenter or may operate at a remote location from server 302. In some cases, one or more data stores 310 may reside on a non-transitory storage medium within the server 302. Other data stores 310 and back-end servers 312 may be remote from server 302 and configured to communicate with server 302 via one or more networks 320. In certain embodiments, data stores 310 and back-end servers 312 may reside in a storage-area network (SAN), or may use a storage-as-a-service (STaaS) architectural model.

With reference to FIG. 4, an illustrative set of data stores and/or data store servers is shown, corresponding to the data store servers 104 of the electronic transfer network 100 discussed above in FIG. 1. One or more individual data stores 411-415 may reside in storage on a single computer server 104 (or a single server farm or cluster) under the control of a single entity, or may reside on separate servers operated by different entities and/or at remote locations. In some embodiments, data stores 411-415 may be accessed by the data management server 102 and/or other devices and servers within the network 100 (e.g., client devices 106, external systems 110, administrator servers 116, etc.). Access to one or more of the data stores 411-415 may be limited or denied based on the processes, user credentials, and/or devices attempting to interact with the data store.

The paragraphs below describe examples of specific data stores that may be implemented within some embodiments of an electronic transfer network 100. It should be understood that the below descriptions of data stores 411-415, including their functionality and types of data stored therein, are illustrative and non-limiting. Data stores server architecture, design, and the execution of specific data stores 411-415 may depend on the context, size, and functional requirements of an electronic transfer network 100. For example, in a secure data transfer systems 100 used for professional training, separate databases or file-based storage systems may be implemented in data store server(s) 104 to store trainee and/or trainer data, training module data and content descriptions, training results, evaluation data, and the like. In contrast, in electronic transfer systems 100 used to provide electronic advertising or other content from content providers to client devices, separate data stores may be implemented in data stores server(s) 104 to store listings of available content and descriptions, content usage statistics, client device profiles, account data, network usage statistics, etc.

A user profile data store 411 may include information relating to the end users within the electronic transfer network 100. This information may include user characteristics such as the user names, access credentials (e.g., logins and passwords), user preferences, and information relating to any previous user interactions within the electronic transfer network 100 (e.g., requested data, provided data, system usage data/statistics, associated users, etc.).

An accounts data store 412 may generate and store account data for different users in various roles within the electronic transfer network 100. For example, accounts may be created in an accounts data store 412 for individual end users, administrator users, and external entities such as businesses, governmental or educational institutions. Account data may include account types, current account status, account characteristics, and any parameters, limits, restrictions associated with the accounts.

A content/security credential data store 413 may include access rights and security information for the electronic transfer network 100 and specific files/content resources. For example, the content/security credential data store 413 may include login information (e.g., user identifiers, logins, passwords, etc.) that can be verified during login attempts by users and/or client devices 106 to the network 100. The content/security credential data store 413 also may be used to store assigned user roles and/or user levels of access. For example, a user's access level may correspond to the sets of data and/or the client or server applications that the user is permitted to access. Certain users and/or client devices may be permitted or denied access to certain applications and resources based on their access level, subscription level, etc. Certain users and/or client devices 106 may have supervisory access over one or more end users accounts and/or other client devices 106, allowing the supervisor to access all or portions of the user's content access, activities, etc. Additionally, certain users and/or client devices 106 may have administrative access over some users and/or some applications in the electronic transfer network 100, allowing such users to add and remove user accounts, modify user access permissions, perform maintenance updates on software and servers, etc.

A content library data store 414 may include information describing the individual data items (or resources) available via the electronic transfer network 100. In some embodiments, the content data store 414 may include metadata, properties, and other characteristics associated with the data items stored in the content server 112. Such data may identify one or more aspects or attributes of the associated data items, for example, subject matter or access level of the content resources, license attributes of the data items (e.g., any limitations and/or restrictions on the licensable use and/or distribution of the data items), price attributes of the data items (e.g., a price and/or price structure for determining a payment amount for use or distribution of the data items), language and geographic associations with the data items, and the like. In some embodiments, the content data store 414 may be configured to allow updating of data item metadata or properties, and to allow the addition and/or removal of information relating to the data items. For example, item relationships may be implemented as graph structures, which may be stored in the content data store 414 or in an additional data store for use by selection algorithms along with the other metadata.

In addition to the illustrative data stores described above, data store server(s) 104 (e.g., database servers, file-based storage servers, etc.) may include one or more external data aggregators 415. External data aggregators 415 may include third-party data sources accessible to the electronic transfer network 100, but not maintained by the electronic transfer network 100. External data aggregators 415 may include any electronic information source relating to the users, data items, or applications of the electronic transfer network 100. For example, external data aggregators 415 may be third-party data stores containing demographic data, education related data, financial data, consumer sales data, health related data, and the like. Illustrative external data aggregators 415 may include, for example, social networking web servers, public records data stores, educational institution servers, business servers, consumer sales data stores, medical record data stores, etc. Data retrieved from various external data aggregators 415 may be used to verify and update user account information, suggest or select user content, and perform user and content evaluations. In some cases, external data aggregators 415 may correspond to external servers/systems 110.

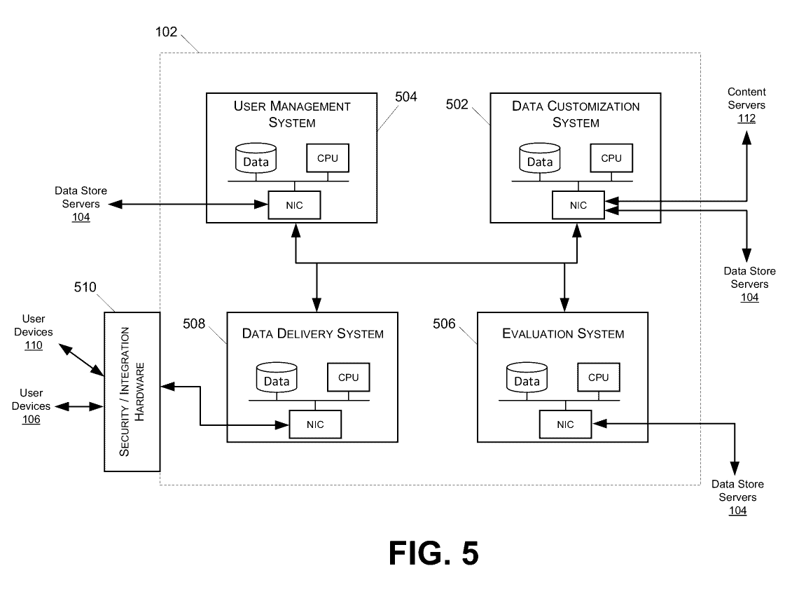

With reference now to FIG. 5, a block diagram is shown illustrating an embodiment of one or more data management servers 102 within an electronic transfer network 100. As discussed above, data management server(s) 102 may include various server hardware and software components that manage the content resources within the electronic transfer network 100 and provide interactive and adaptive content to users on various client devices 106. For example, data management server(s) 102 may provide instructions to and receive information from the other devices within the electronic transfer network 100, in order to manage and transmit data resources, user data, and server or client applications executing within the network 100.

A data management server 102 may include a data customization system 502. The data customization system 502 may be implemented using dedicated hardware within the electronic transfer network 100 (e.g., a data customization server 502), or using designated hardware and software resources within a shared data management server 102. In some embodiments, the data customization system 502 may adjust the selection and adaptive capabilities of data resources to match the needs and desires of the users and/or client devices 106 receiving the content. For example, the data customization system 502 may query various data stores and servers 104 to retrieve user information, such as user preferences and characteristics (e.g., from a user profile data store 411), location/geographic information associated with users and/or client devices 106, user access restrictions to data recourses (e.g., from an access credential data store 413), previous user activity within the network 100, and the like. Based on the retrieved information from data stores 104 and other data sources, the data customization system 502 may modify content resources for individual users and/or individual client devices 106.

A data management server 102 also may include a user management system 504. The user management system 504 may be implemented using dedicated hardware within the electronic transfer network 100 (e.g., a user management server 504), or using designated hardware and software resources within a shared data management server 102. In some embodiments, the user management system 504 may monitor the activities of users and/or user devices 106 with respect to various data resources. For example, the user management system 504 may query one or more databases and/or data store servers 104 to retrieve user data such as associated data resources, access and completion status, results, and the like.

A data management server 102 also may include an evaluation system 506. The evaluation system 506 may be implemented using dedicated hardware within the electronic transfer network 100 (e.g., an evaluation server 506), or using designated hardware and software resources within a shared data management server 102. The evaluation system 506 may be configured to receive and analyze information from client devices 106. For example, various data received by users via client devices 106 may be compiled and analyzed, and then stored in a data store 104 associated with the user and/or data item. In some embodiments, the evaluation server 506 may analyze the information to determine the effectiveness or appropriateness of data resources with a user or user group, for example, based on subject matter, age group, skill level, or the like. In some embodiments, the evaluation system 506 may provide updates to the data customization system 502 or the user management system 504, with the attributes of one or more data resources or groups of resources within the network 100.

A data management server 102 also may include a data delivery system 508. The data delivery system 508 may be implemented using dedicated hardware within the electronic transfer network 100 (e.g., a data delivery server 508), or using designated hardware and software resources within a shared data management server 102. The data delivery system 508 may receive data from the data customization system 502 and/or from the user management system 504, and transmit the resources to client devices 106. In some embodiments, the data delivery system 508 may determine the appropriate presentation format for the data resources based on the user characteristics and preferences, and/or the device capabilities of client devices 106. If needed, the data delivery system 508 may convert the content resources to the appropriate presentation format and/or compress the content before transmission. In some embodiments, the data delivery system 508 may also determine the appropriate transmission media and communication protocols for transmission of the data to and from client devices 106.

In some embodiments, the data delivery system 508 may include specialized security and integration hardware 510, along with corresponding software components to implement the appropriate security features for data transmission and storage, to provide the supported network and client access models, and to support the performance and scalability requirements of the network 100. The security and integration layer 510 may include some or all of the security and integration components 308 discussed above in FIG. 3, and may control the transmission of data, as well as the receipt of requests and data interactions, to and from the client devices 106, external servers 110, administrative servers 116, and other devices in the network 100.

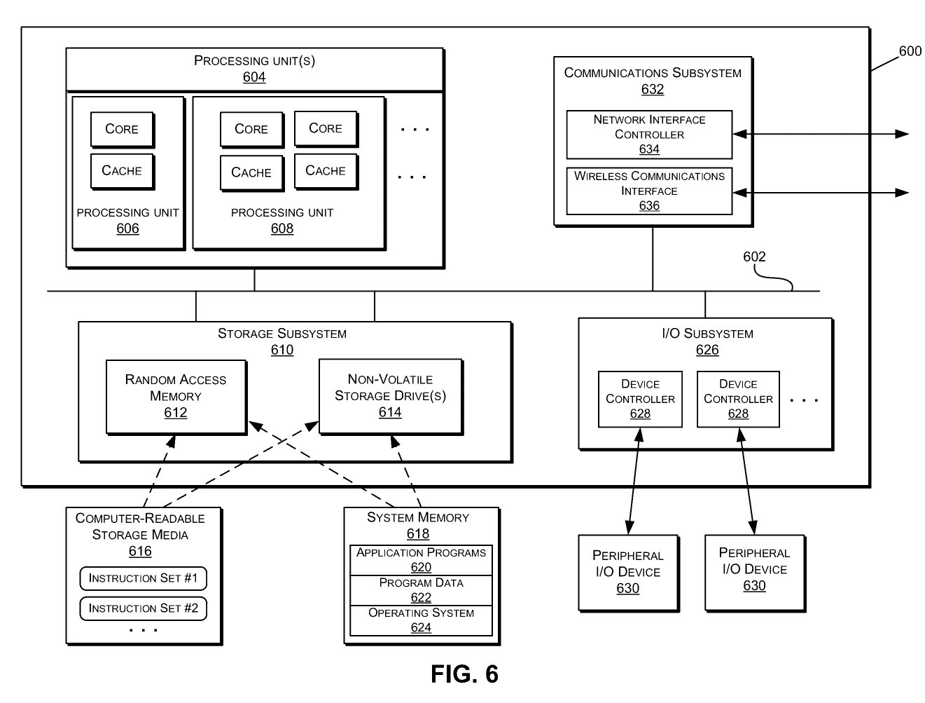

With reference now to FIG. 6, a block diagram of an illustrative computer system is shown. The system 600 may correspond to any of the computing devices or servers of the electronic transfer network 100 described above, or any other computing devices described herein. In this example, computer system 600 includes processing units 604 that communicate with a number of peripheral subsystems via a bus subsystem 602. These peripheral subsystems include, for example, a storage subsystem 610, an I/O subsystem 626, and a communications subsystem 632.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 604, which may be implemented as one or more integrated circuits (e.g., a conventional microprocessor or microcontroller), controls the operation of computer system 600. One or more processors, including single core and/or multicore processors, may be included in processing unit 604. As shown in the figure, processing unit 604 may be implemented as one or more independent processing units 606 and/or 608 with single or multicore processors and processor caches included in each processing unit. In other embodiments, processing unit 604 may also be implemented as a quad-core processing unit or larger multicore designs (e.g., hexa-core processors, octo-core processors, ten-core processors, or greater. As discussed above, in some cases, processing unit 604 may include one or more specialized ASICs designed and configured for cryptocurrency mining and/or specialized cryptographic hardware for handling cryptocurrency transactions.

Processing unit 604 may execute a variety of software processes embodied in program code, and may maintain multiple concurrently executing programs or processes. At any given time, some or all of the program code to be executed can be resident in processor(s) 604 and/or in storage subsystem 610. In some embodiments, computer system 600 may include one or more specialized processors, such as digital signal processors (DSPs), outboard processors, graphics processors, application-specific processors, and/or the like.

I/O subsystem 626 may include device controllers 628 for one or more user interface input devices and/or user interface output devices 630. User interface input and output devices 630 may be integral with the computer system 600 (e.g., integrated audio/video systems, and/or touchscreen displays), or may be separate peripheral devices which are attachable/detachable from the computer system 600.

Input devices 630 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 630 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 630 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 630 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 600 to a user or other computer. For example, output devices 630 may include, without limitation, a variety of display devices that visually convey text, graphics and audio/video information such as monitors, printers, speakers, headphones, automotive navigation systems, plotters, voice output devices, and modems.

Computer system 600 may comprise one or more storage subsystems 610, comprising hardware and software components used for storing data and program instructions, such as system memory 618 and computer-readable storage media 616. The system memory 618 and/or computer-readable storage media 616 may store program instructions that are loadable and executable on processing units 604, as well as data generated during the execution of these programs.

Depending on the configuration and type of computer system 600, system memory 618 may be stored in volatile memory (such as random access memory (RAM) 612) and/or in non-volatile storage drives 614 (such as read-only memory (ROM), flash memory, etc.) The RAM 612 may contain data and/or program modules that are immediately accessible to and/or presently being operated and executed by processing units 604. In some implementations, system memory 618 may include multiple different types of memory, such as static random access memory (SRAM) or dynamic random access memory (DRAM). In some implementations, a basic input/output system (BIOS), containing the basic routines that help to transfer information between elements within computer system 600, such as during start-up, may typically be stored in the non-volatile storage drives 614. By way of example, and not limitation, system memory 618 may include application programs 620, such as client applications, Web browsers, mid-tier applications, server applications, etc., program data 622, and an operating system 624.

Storage subsystem 610 also may provide one or more tangible computer-readable storage media 616 for storing the basic programming and data constructs that provide the functionality of some embodiments. Software (programs, code modules, instructions) that when executed by a processor provide the functionality described herein may be stored in storage subsystem 610. These software modules or instructions may be executed by processing units 604. Storage subsystem 610 may also provide a repository for storing data used in accordance with the present invention.

Storage subsystem 610 also may include a computer-readable storage media reader that can further be connected to computer-readable storage media 616. Together and, optionally, in combination with system memory 618, computer-readable storage media 616 may comprehensively represent remote, local, fixed, and/or removable storage devices plus storage media for temporarily and/or more permanently containing, storing, transmitting, and retrieving computer-readable information.

Computer-readable storage media 616 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 600.

By way of example, computer-readable storage media 616 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 616 may include, but is not limited to, Zip® drives, flash memory cards, universal serial bus (USB) flash drives, secure digital (SD) cards, DVD disks, digital video tape, and the like. Computer-readable storage media 616 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Communications subsystem 632 may provide a communication interface from computer system 600 and external computing devices via one or more communication networks, including local area networks (LANs), wide area networks (WANs) (e.g., the Internet), and various wireless telecommunications networks. As illustrated in FIG. 6, the communications subsystem 632 may include, for example, one or more network interface controllers (NICs) 634, such as Ethernet cards, Asynchronous Transfer Mode NICs, Token Ring NICs, and the like, as well as one or more wireless communications interfaces 636, such as wireless network interface controllers (WNICs), wireless network adapters, and the like. Additionally and/or alternatively, the communications subsystem 632 may include one or more modems (telephone, satellite, cable, ISDN), synchronous or asynchronous digital subscriber line (DSL) units, FireWire® interfaces, USB® interfaces, and the like. Communications subsystem 636 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 632 may be detachable components coupled to the computer system 600 via a computer network, a FireWire® bus, or the like, and/or may be physically integrated onto a motherboard of the computer system 600. Communications subsystem 632 also may be implemented in whole or in part by software.

In some embodiments, communications subsystem 632 may also receive input communication in the form of structured and/or unstructured data feeds, event streams, event updates, and the like, on behalf of one or more users who may use or access computer system 600. For example, communications subsystem 632 may be configured to receive data feeds in real-time from users of social networks and/or other communication services, web feeds such as Rich Site Summary (RSS) feeds, and/or real-time updates from one or more third party information sources (e.g., data aggregators 309). Additionally, communications subsystem 632 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 632 may output such structured and/or unstructured data feeds, event streams, event updates, and the like to one or more data stores 104 that may be in communication with one or more streaming data source computers coupled to computer system 600.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

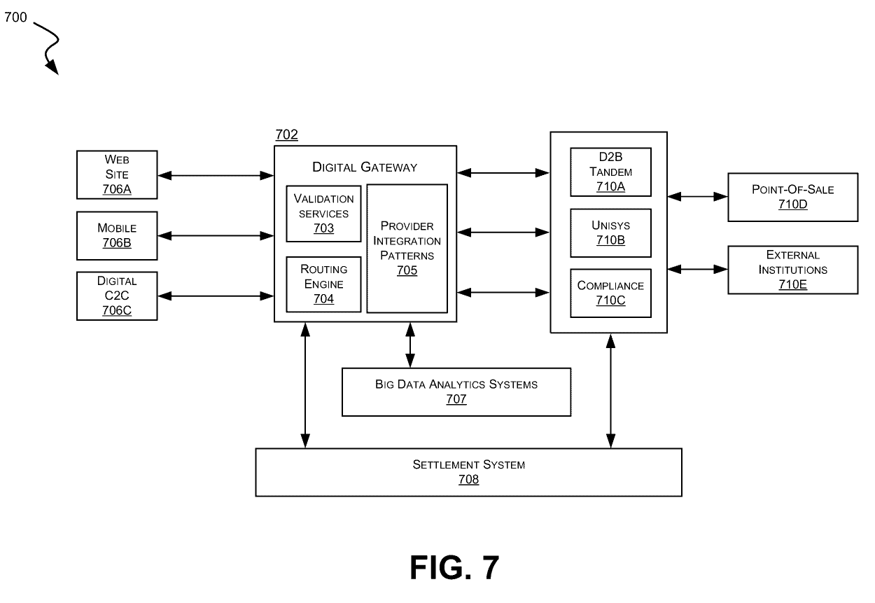

With reference now to FIG. 7, a block diagram is shown illustrating an example transaction processing system 700 which may be configured to control and optimize processing of complex multi-party transactions initiated via transaction client devices. In this example, system 700 includes a digital gateway 702, which also may be referred to as a homogenization system in some instances. As discussed below, digital gateway 702 may include one or more computer servers configured to receive transaction requests from various client devices 706a-706c (which collectively and/or individually may be referred to as client device(s) 706), and then control the processing flow of the transaction requests via various other systems. After receiving a transaction request via client device 706 and validating the request via validation services 703, the digital gateway 702 may determine one or more particular transaction processors to handle the request, and then route the request via routing engine 704. In this example, the digital gateway 702 includes a plurality of provider integration patterns 705 corresponding to various different transaction processors. Communication between the digital gateway 702 and the transaction processors may be performed via the D2B tandem system 710A, Unisys system 710B, and/or compliance system 710C. In this example, transaction processors may include point-of-sale systems 710D and/or external institutions 710E.

Additionally, digital gateway 702 may be configured to use one or more big data analytics systems 707 to store transaction data and perform analyses of transaction requests received from client device 706. For example, digital gateway 702 may initiate a risk analysis via the analytics systems 707 to identify and calculate risk factors associated with a transaction request, based on associated user data, transaction patterns, etc. The digital gateway 702 also may be configured to communicate with one or more settlement systems 708 to finalize and complete the transaction. Settlement systems 708 also may receive data from transaction processors 710D-710E, via the D2B tandem system 710A, Unisys system 710B, and/or compliance system 710C, during settlement processes. Additionally, transaction storage, logging, and reporting systems may be included in system 700 in some embodiments.

In various different implementations and embodiments, the digital gateway 702 may be configured to receive and manage different types of transactions. For example, transactions between a sender and receiver may refer to transfers of various different types of data items (e.g., files, database records, media or other content resources, etc.), as well as other secure data transactions or other interactions between a sender client device 706 and a receiver device 706 or receiver system 710. In some embodiments, system 700 may be configured to operate as a value (or monetary) transfer system, by which users at client devices 706 may initiate value transfers to users at receiver devices 706 at different locations. In such cases, the transaction requests received from client devices 706 may correspond to money transfers or retail purchases. The recipients of the output values of such transactions may be end users operating other client devices 706, or external systems 710 such as retail systems 710D or financial institutions. For such transactions, the sender and receiver may be associated with different geographic areas and/or different jurisdictions where different value transfer rules may apply. Thus, in such embodiments, transaction processing system 700 may be applied to transfers of currency, or any other medium of exchange (e.g., credit, gift cards or certificates, points in a user point system, etc.), between users in different areas, regions, or jurisdictions.

In other embodiments, the transaction processing system 700 may be configured to perform other types of multi-party data transfers and/or secure transactions, such as transfers of data items including secure files, records, and/or content resources, from a sender client device 706 in one location and/or on one network, to a receiver device 706 or system 710 in another location and/or on another network. In such embodiments, the sender and receiver locations may correspond to different geographic areas and/or different computing infrastructures (e.g., different data centers, different networks, etc.) over which the secure data transfer may be performed. Transaction processing systems 710A-710C, in such embodiments, may correspond to authentication systems, data access/permission systems, subscription monitor systems, network access providers, and/or any other servers that may be used to monitor, permit/deny access, and/or enable data transfers. In still other implementations, systems 700 may be implemented as part of interactive gaming systems, educational and profession training systems, and/or social network systems, to enable the transfer of certain data or values (e.g., points, credits, resources, etc.) between system users.

In some embodiments, the digital gateway 702 also may be configured to normalize transaction request data across different transaction types, allowing the transaction request data to be transmitted in a uniform manner to related back-end systems, partner systems, and transaction processors. For example, for value transfer transactions (e.g., money transfers, network-based purchases, etc.), the digital gateway 702 may implement a set of common reconciliation and settlement event types to be applied to different and unrelated payment processors. As an example, the common set of reconciliation and settlement event types may include: settled, refunded, charged_back, chargeback_reversed, refund_reversed, fee, misc. In such cases, settlements may be in any currency, and may be gross or net settlements. The digital gateway 702 may receive settlement notifications from various payment processors, matches the settlement notifications to known transactions processed by the system 700, determine the correct mapping to the common reconciliation and settlement event types, and then generates a single consistent settlement record. Such settlement records may include all relevant information about the transaction and its current state, and may include descriptive text to assist in automatically matching deposits to bank statements. In this manner, the system 700 may add, remove, and exchange payment processors without impacting financial accounting systems.

Additionally, when configured to handle value transfer transactions, the digital gateway 702 may implement a common set of payment flow types capable of handling payment transactions for any and all payment types. The common set of payment flow types may include, for example, immediate push, immediate pull, delayed push, and delayed pull. In some embodiments, by implementing only these four flows, and allowing for a) insertion of logos, text, and other payment-specific information; and b) allowing the user to supply supporting information, either freeform or menu-based; these web flows need only be built once but may support any and all payment types, including existing payment types and those not yet developed. In some examples, the common set of payment flow types may support the following attributes: (1) immediately including the ability to redirect to a customer's bank for authentication; (2) delayed support for payments that are completed offline; (3) push support for all payments initiated by a customer's bank; and (4) pull support for all payments initiated by a merchant. When implementing a common set of payment flow types, the digital gateway 702 may categorize each payment processor into one of the four flows, manage the payment-specific information (input and output), and implement the specific interactions with the payment provider, mapping those interactions to an ideal set of payment-related requests, including: verify, initiate, authenticate, authorize, cancel, refund, and capture. These are the consistent interactions the web has with the digital gateway 702 to process any payment type, and the digital gateway 702 may provide appropriate responses and directions depending on the payment type. In this manner, payment types may be added, removed, and exchanged within the system 700, without impacting online and mobile application systems.

Additionally, when configured to handle value transfer transactions, the digital gateway 702 may automate the collection and tracking of payment disputes, and may create a common set of dispute attributes and events, in order to support collection and dispute management systems and processes for multiple different payment processors. In order to support any payment processors, including those not yet developed, support may be provided for disputes in any currency, arriving within any time range, and constrained by one or more rules including an expiration time. In such cases, the digital gateway 702 may take dispute notifications from any given payment processor, match the dispute notifications to known transactions processed by the system 700, determine the correct mapping to these event types, and generate a single consistent dispute record. This dispute record may include all relevant information about the transaction and its current state, and may allow workflow management of the dispute process and any new information acquired. In this manner, payment processors may be added, removed, and exchanged within the system 700, without impacting dispute management systems.

Within the transaction processing system 700, transaction client devices 706 may include any types of computing devices discussed above in connection with user devices 106, 206, 600, etc. For example, one or more client devices 706 may include desktop computers, servers, television set-top boxes, and home gaming systems, while other client devices 706 may include various mobile devices such as laptop computers, tablet computers, smart phones, smart watches, wearable computing devices, and vehicle-based computing systems. Each client device 706 may include some or all of the components of device 600, discussed above. However, it should be understood that these examples of user device architectures are illustrative and non-limiting, and that different configurations of hardware, software, and network components may be used in different user devices.

Further, as noted above, transaction processing system 700 may be implemented to support value transfers, secure data transfers, etc. Accordingly, one or more host applications may execute on the client device 706 to initiate such transactions, for example, messaging applications, social networking application, gaming applications, electronic mail client applications, online merchant client applications, and other types of interactive or collaborative user software applications. In some embodiments, the transactions initiated within the host applications may be funds transfers between users of the host application and/or client device 706, such as the transfers between current parties of a messaging conversation, users of a social networking application, users within a collaborative gaming environment, or for an online transaction, etc. The initiation of such transactions may cause a transaction request to be sent to the digital gateway 702, including transaction request data (e.g., sender data, receiver data, location data, transaction/payment type data, etc.).

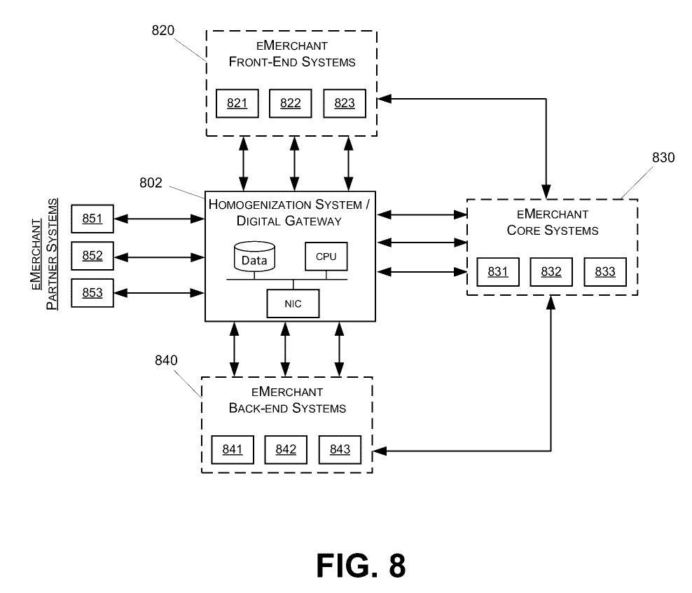

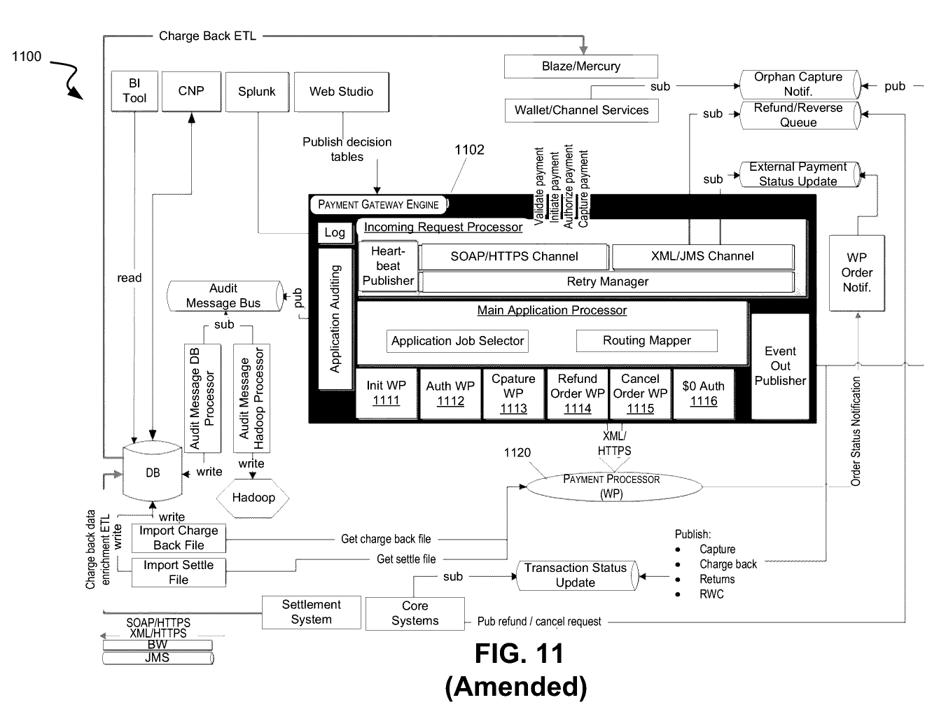

In order to perform these features and the additional functionality describes herein, the digital gateway 700 may be implemented on a single computer server or a multiple different servers in collaboration, operating at one or more data centers/physical locations. Examples of possible architectures and component diagrams of digital gateways 702 and transaction processing systems are discussed further below in reference to FIGS. 8 and 11. Additionally, although the physical network components have not been shown in FIG. 7 so as not to obscure the other elements depicted, it should be understood that any of the network hardware components and network architecture designs may be implemented in various embodiments to support communication between the servers and devices in the system 700. Additionally, different client devices 706 and servers within the system 700 may use different networks and networks types to communicate with each other and/or with the digital gateway 702, including one or more telecommunications networks, cable networks, satellite networks, cellular networks and other wireless networks, and computer-based IP networks, and the like. Further, certain components within system 700 may include special purpose hardware devices and/or special purpose software, such as those included in I/O subsystems systems, positioning systems, and storage and networking capabilities of the various client devices 706, as well as those within the processing engines, subcomponents, and data stores of the digital gateway 702.

Further, in some embodiments, the digital gateway 702 and transaction processing system 700 may be integrated within, or configured to operate in collaboration with, one or more electronic data transfer networks 100. For example, system 700 may be the same as, or may operate within or in collaboration with, any of the electronic data transfer networks 100 described above. Thus, specific examples of transaction processing systems 700 may include, without limitation, secure systems for transferring value and other media of exchange, eCommerce systems, multi-entity systems for exchanging content resources (e.g., media files, educational and professional training content, gaming content, Internet content, etc.), and other electronic data transfer systems. In such cases, the digital gateway 702 and its associated components, subsystems, and data stores may correspond to and may be implemented within a data management server 102 and/or a data store server 104, and transaction client devices 706 may correspond to the client devices 106 and/or external systems described above in reference to network 100.

Referring now to FIG. 8, another example transaction processing system is shown, specifically for processing eMerchant transactions, using a homogenization system and digital gateway 802, related eMerchant front-end systems 821-823 (collectively 820), eMerchant back-end systems 841-843 (collectively 840), eMerchant core systems 831-833 (collectively 830), and eMerchant partner systems 851-853. In this example, homogenization system/digital gateway 802 may be configured to homogenize various processes for the various eMerchant systems 820-840, and selecting and routing various transactions/processes between eMerchant systems 820-840 and partner systems 851-853. For example, when implemented as a homogenization system/digital gateway 802 may homogenize various processes of the front-end systems 821-823 of an eMerchant or money transfer service (e.g., online payment flows and exceptions of heterogeneous global payment method provided by partner systems 851-853), may homogenize various core processes 831-833 of the eMerchant or money transfer service (e.g., chargeback, returns, disputes and collections processes of heterogeneous global payment method provided by partner systems 851-853), and also may homogenize various back-end processes 841-843 of the eMerchant or money transfer service (e.g., reconciliation and settlement processes of heterogeneous global payment method provided by partner systems 851-853). Additionally, as discussed below in more detail, the homogenization system/digital gateway 802, when implemented as a payment gateway, may be configured to automatically select and route payment processing from multiple payment gateways and processors, to choose the optimal pathway for international debit and credit card payments using business rules based on real time data.

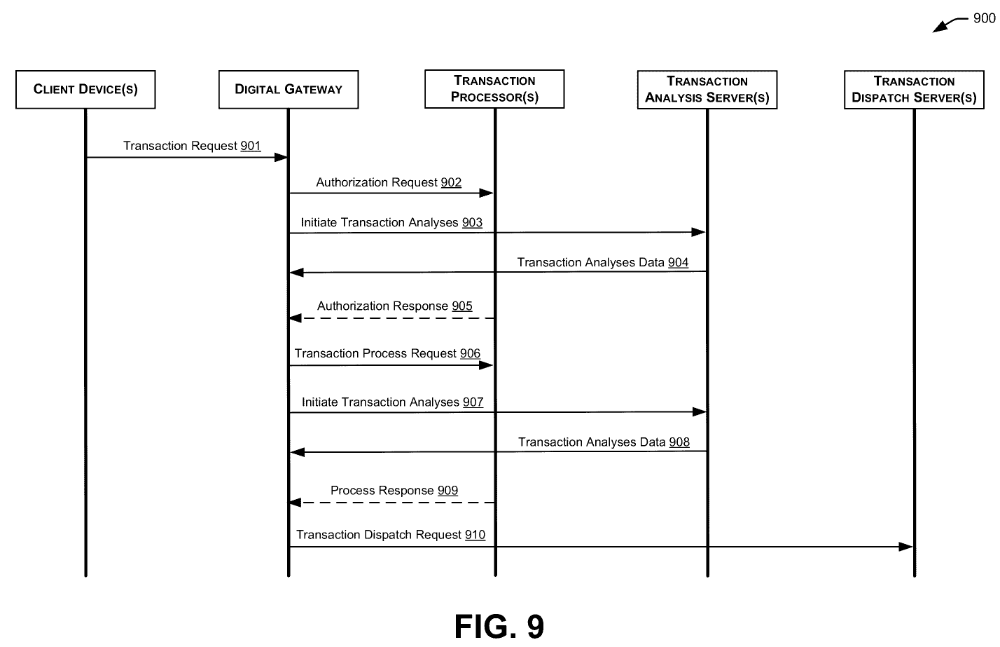

Referring now to FIG. 9, a swim lane diagram is shown illustrating an example process of receiving and processing transaction requests using a digital gateway and related back-end systems. As shown in the figure, the steps in this process may be performed by one or more components in the systems described above (e.g., system 700), such as one or more client devices 706, a digital gateway server 702, one or more transaction processors (e.g., 710A-710B), one or more transaction analysis servers (e.g., 707 and 710C), and one or more transaction dispatch servers (e.g., 708 and 710D-710E). However, it should be understood that the various features and processes described herein, including determining one or more particular transaction processors to handle a transaction, analyzing transaction requests, and determining when transaction request should be captured, processed, and/or dispatched based on the analyses and other factors, need not be limited to the specific systems and hardware implementations described above in FIGS. 1-9.

In step 901, the digital gateway 702 may receive a transaction request from a client device 706. The request may be received from the client device via a web site 706A, a mobile application 706B, a digital C2C client 706C, and/or through the additional client devices and client applications described herein. Further, as discussed above, the transaction request in step 901 may correspond to a request to transfer value (e.g., a money transfer request, online purchase transaction request, etc.), or may correspond to other types of secure data transfers, etc.

In some embodiments, the transaction request may include various transaction data such as sender and recipient user/device data and associated locations, transaction type, transaction amount, etc. For example, for value transfer transactions, a sender client device 706 may include a sender and receiver, along with associated sender and receiver locations or jurisdictions (e.g., countries, states, and/or regions), as well as payment type (e.g., credit, bank account, ACH, and additional payment methods), and amount. Additionally, transaction requests may include time/date information at which the transaction is to be processed, and/or an expiration time or other conditions associated with the completion of the transaction. In some cases, a transaction request also may indicate particular communication networks or transmission channels, security requirements of the transaction, etc., to be enforced by the digital gateway 702 during the subsequent phases of the transaction.

After receiving the transaction request in step 901, the digital gateway 702 may determine one or more transaction processors to be used to process the request, and may transmit authorization messages to the determined transaction processor(s) in step 902. The determination of a particular transaction processor to handle a transaction request may be based on the data received in the transaction request, such as user data, sender and receiver locations, transaction (e.g., payment) type and amount, etc. For example, for value transfer transactions, a first payment processor may serve only certain countries, a certain subset of payment types, and a certain amount range, whereas a second payment processor may serve a different subset of countries, payment types, and amounts.

In some cases, the digital gateway 702 may determine that only a single transaction processor is available to process the transaction request received in step 901, and may transmit an authorization request to the transaction processor in step 902. However, in other cases, the digital gateway 702 may identify multiple different transaction processors capable of processing the transaction request. In these cases, the digital gateway 702 may apply a set of predetermined rules/logic stored in the routing engine 704 to determine an optimal transaction processor for handling the request. For example, for value transfer transactions, the rules/logic implemented by the routing engine 704 may relate to country, currency type, transaction amount, least cost fees, contractual minimum usage requirements with transaction processors, processor incentives, decline rates, multivariate testing, DBA, and merchant descriptors. Rules may use any combination of these factors any other aspect of the request and characteristics of the transaction processors to determine the routing of the transaction request. Additionally, the digital gateway 702 may track payment data it generates internally in response to interactions with payment processors, and may combine the data with incoming invoices, chargeback files, invoices, and other partner-provided data to enable decisions configured in and managed by the rules/logic. Such rules may be added, removed, and changed by an administrator (e.g., a payments manager user) of the system 700, who also may drive automated decisions based on various thresholds (e.g. financial or numerical), randomized tests, time of day, week, month, or year, and may also support multivariate testing driven by upstream systems, such as changing the behavior of a payment method at the direction of multivariate testing performed in the customer website.

After determining one or more transaction processors to handle the request, the digital gateway 702 may transmit an initial authorization message to the transaction processor(s) in step 902. An authorization message may include sufficient transaction information (e.g., sender and recipient information, account numbers, locations, transaction amounts, etc.) to allow the transaction processor to determine whether or not the transaction request can be completed, but without actually processing the request. In step 905, the transaction processor returns a response to the authorization request sent in step 902. The authorization response received by the digital gateway 702 in step 905 may indicate whether or not the transaction request has been successfully authorized to be processed by the transaction processor, and/or may include certain conditions relating to the processing of the transaction (e.g., an expiration time). Additionally, as indicated in the figure, step 905 may be optional. For instance, in some cases, transaction processor might only return a response in the event that the transaction request is denied or generates an error or exception.

In this example, while the authorization request is being processed by the transaction processor(s), the digital gateway 702 may initiate one or more transaction analyses in step 903, and may receive responses to the transaction analyses in step 904. Such analyses may include, for example, transaction risk analyses, compliance analyses, etc., and may be initiated on the assumption that the transaction will be authorized by at least one transaction processor. For example, when the transaction request is a value transfer request, a risk analysis may calculate a risk of that the transaction will be canceled before processing, will be canceled after processing (e.g., via a refund request), will fail the authorization request, will pass the authorization request and then be defaulted upon, will be determined to be a fraudulent transaction, etc. As discussed below, all of these risks may have an impact on the subsequent determinations to capture and process the transaction, and to dispatch (e.g., remit payment for) the transaction.

In step 906, assuming that the transaction has been authorized by at least one transaction processor, the digital gateway 702 may initiate the processing of the transaction request by transmitting processing messages to the transaction processor(s). The determination by the digital gateway 702 to process the transaction may coincide with a capturing of the transaction request. In some embodiments, after the transaction request capture, the transaction cannot be canceled or rolled-back, but instead can only be undone by a second transaction. For value transfer transactions, certain transaction processing tasks may be multi-step transactions involving more than one transaction processor. For instance, funds transfers between different jurisdictions may require coordination among transaction processors. In such examples, the digital gateway 702 may issue multiple transaction process requests to different transaction processors, and may manage and coordinate the multi-party transaction processing from the centralized system. In step 909, response(s) to the transaction process requests may be received by the digital gateway 702 from the transaction processors.

In this example, while the transaction is being processed by the transaction processor(s), the digital gateway 702 may initiate one or more additional transaction analyses in step 907, and may receive responses to the transaction analyses in step 908. The transaction analyses of steps 907-908 also may include risk analyses, compliance analyses, and any other transaction analyses discussed above in steps 903-904. However, unlike the transaction analyses of steps 903-904, the transaction analyses of steps 907-908 may be initiated after confirming that the transaction request has been successfully authorized. As discussed below, the risk, compliance, and other analyses performed in steps 907-908 may have an impact on the subsequent determinations to dispatch (e.g., remit payment for) the transaction. Finally, in step 910, the digital gateway 702 may initiate transaction dispatches to one or more transaction dispatch servers. For example, in value transfer transactions, transaction dispatches may include remittance instructions from the digital gateway 702 to make payment available to the recipient in the money transfer or eMerchant in an online purchase transaction.

Thus, the process illustrated in FIG. 9 describes end-to-end transaction management and processing by the centralized digital gateway 702, which may instruct and coordinate separate systems to receive and transaction requests, authorize transactions, capture and process transactions, and dispatch transactions. In this example, digital gateway 702 may manage and handle the transaction processing using a single flow that is independent of the transaction type and independent of the available and selected transaction processors. The single flow executed by the digital gateway 702 may implement a set of rules/logic to control transaction authorization, transaction processing, and transaction dispatch. Further, as discussed above, the rules implemented by the digital gateway 702 may be based on the results of the transaction analyses, such as risk and compliance analyses performed at various times during the end-to-end transaction management and processing.

As noted above, the rules/logic executed by the digital gateway 702 may include determining when to authorize transaction requests, when to capture and process transactions, and when to dispatch transactions, based on risk assessments and other analyses. For example, if a transaction risk analysis performed in steps 903-904 indicates a relatively low transaction risk, then the digital gateway 702 may initiate the transaction processing in step 906 and/or the transaction dispatching (e.g., remittance) earlier than if the risk analysis were to indicate a higher transaction risk. In some cases, if the risk analysis determines a low risk level for a transaction below a particular threshold, then the digital gateway 702 may initiate processing of the transaction (step 906) before receiving the authorization response (step 905). For cases in which an authorization response is only transmitted in the event of an authorization failure (e.g., ACH), then the digital gateway 702 may initiate processing of the transaction (step 906) earlier than the typical time period waiting for a failed transaction response. Additionally, for low risk and/or low value transfers, the digital gateway 702 may initiate the dispatch/remittance process (step 910) before receiving the process response (step 909), and even potentially before receiving the authorization response (step 905).

Further, in some embodiments, the digital gateway 702 may maintain and use a data store storing different authorization response times for different transaction processors, so that the transaction processing (step 906) and transaction dispatching (step 910) may be initiated sooner for faster transaction processors and later for slower transaction processors. Additionally, the process illustrated in FIG. 9 allows the digital gateway 702 to manage the transaction authorization, capturing and processing, and/or transaction dispatching processes using transaction-specific messages from the digital gateway to related systems, rather than via pre-scheduled batch processing.

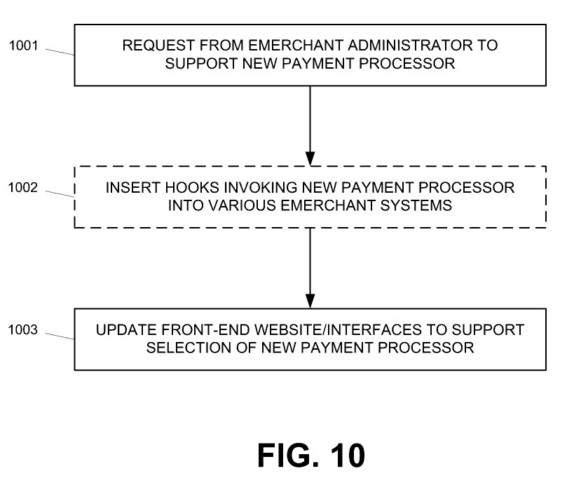

In FIGS. 10-12, example processes and systems are illustrated based on a specific implementation of a transaction processing system 700 configured as an eMerchant payment transaction processing system. Referring now to FIG. 10, a flow diagram is shown illustrating an example process of configuring various eMerchant systems support a new payment processor using a digital payment gateway (e.g., eMerchant system 820). In contrast to the previous solutions, the example process shown in FIG. 10 and other examples described herein may use a digital payment gateway to normalize and homogenize various processes of one or more eMerchant systems, including various front-end systems 820, core systems (e.g., payment/transaction) 830, and back-end databases and systems 840. As described below in more detail, the homogenization system/digital gateway 802 may handle some or all communication between the various eMerchant systems 820-840 and external partner systems 850 (e.g., payment processing partners). In some cases, the homogenization system/digital gateway 802 may normalize the communication and data processing performed by eMerchant systems 820-840 with respect to different payment processing partners, so that an individual eMerchant system/process potentially need not behave any differently depending on which payment processing partners is being used in a particular transaction. In some cases, the specific payment processing partner 851-853 being used for money transfers or other transactions need not be known at all to the eMerchant system/process.

To provide homogenization for the various eMerchant systems 820-840, with respect to different payment processing partners 851-853, the homogenization system/digital gateway 802 may normalize the set of transaction states, behaviors, and interactions that eMerchant systems 820-840. For example, the homogenization system/digital gateway 802 may define a fixed set of states of money transfer transactions (or other transactions used by different types of eMerchant systems), for example, authorized, paid, fully settled, pending, canceled, pending canceled, etc. These transaction states may apply to every transaction processed by any eMerchant system or process, regardless of the specific payment processing partner(s) used to process the transaction payment. Additionally, the homogenization system/digital gateway 802 may use a fixed and predefined format for generating and transmitting data files to eMerchant systems, such that the data file format will be the same regardless of the specific payment processing partner(s) used. Thus, when different payment processing partner(s) transmit data to the homogenization system/digital gateway 802 using different respective formats, the homogenization system/digital gateway 802 may be configured to extract the relevant data and generate data files using homogenized file formats for transmission to the eMerchant systems 820-840. Similarly, each of the eMerchant systems 820-840 may transmit data in an identical and normalized way to the homogenization system/digital gateway 802, regardless of the payment processing partner(s) used, and the homogenization system/digital gateway 802 may extract the relevant data and communicate with the appropriate payment processing partner without the originating systems 830-840 ever needing to know which payment processing partner was selected/used by the homogenization system/digital gateway 802.

Returning again to FIG. 10, various eMerchant systems/processes may be configured to implement new payment types (or remove or modify existing payment types) via homogenization system/digital gateway 802, quickly and without impacting the financial accounting systems, dispute management systems, or other backend systems like settlement or GL, or the eMerchant consuming systems (e.g., online, mobile and kiosk application systems). In step 1001, an eMerchant administrator may transmit a request to the homogenization system/digital gateway 802 indicating a request to implement a new payment type for some or all of the eMerchant systems. In step 1002, in some cases, one or more of the eMerchant systems/processes 820-840 may be modified to insert programmatic hooks necessary to invoke the new payment type. However, as discussed above, step 1002 may be optional in some embodiments. For example, in some embodiments, the homogenization system/digital gateway 802 may completely normalize all behaviors and interactions of a set of eMerchant systems 830-840 with respect to payment processing partners 851-853, so that no changes are required to any of the eMerchant systems/processes 830-840. In step 1003, one or more of the front-end eMerchant consuming systems 820 (e.g., website, mobile applications, kiosk applications, etc.) may be updated to support selection of the new payment type. For example, the design and front-end code of the eMerchant website may be updated to allow customers to select the new payment type in some or all cases, and to transmit data indicating selection of the new payment type to the homogenization system/digital gateway 802 and/or to other eMerchant systems 830-840.

Referring now to FIG. 11, another example system is shown depicting a homogenization system/digital gateway 1102 and various other components within a computing environment supporting techniques for money transfers, eCommerce transactions, and the like. The digital gateway 1102 in this example may correspond to the digital gateway 702 and/or 802 discussed above; however, several additional components and specialized hardware/software systems are illustrated in gateway 1102 and in the related systems of environment 1100. For example, after performing the steps discussed above in FIG. 10 for the addition of the WorldPay (or “WP”) payment processor type, the digital gateway 1102 may include a number of specialized components 1111-1116 for interfacing with and normalizing communication with the WP payment processor 1120.

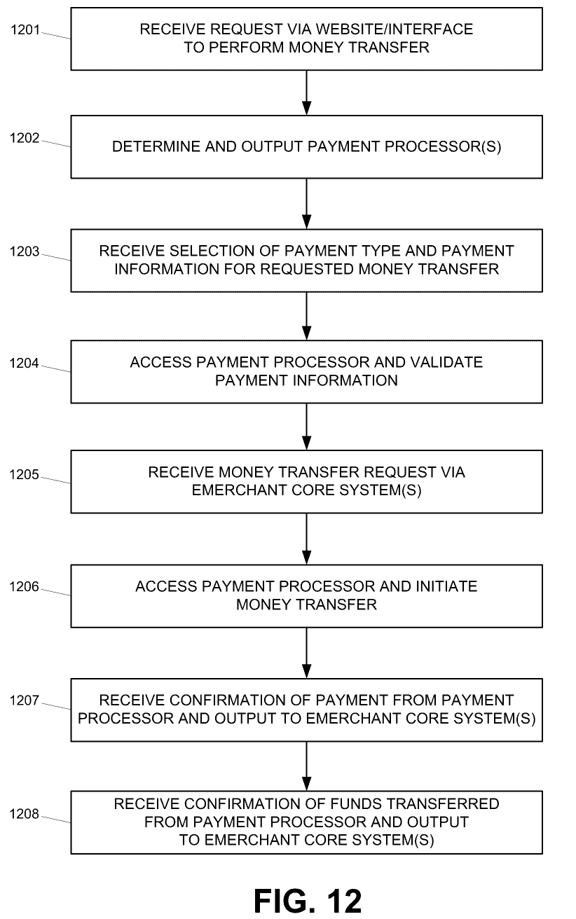

Referring now to FIG. 12, a flow diagram is shown for performing an eMerchant transaction, using a homogenization system/digital gateway (e.g., 702, 802, or 1102) to normalize the transaction steps and communicate with the external eMerchant partner systems 851-853. As discussed above, the eMerchant transaction may include a money transfer or other financial transaction in some cases, in which the homogenization system/digital gateway 802 may correspond to a digital payment gateway, and the eMerchant partner systems may correspond to different payment processing partners 851-853. In step 1201, the homogenization system/digital gateway 802 may receive a request via a website, mobile application, or other eMerchant customer facing front-end system 820 to perform a money transfer. For example, the request received in step 1201 may be a money transfer request including various information such as the country of the sender, the identity of the sender, the country of the receiver, the identity of the receiver, the amount of the requested transfer, the currency type(s) to be received and paid out, a merchant descriptor or other usage data associated with the transfer, etc.

In step 1202, the homogenization system/digital gateway 802 may process the money transfer request received in step 1201 and determine one or more payment processors for the transaction. For example, certain payment processors might only operate in certain countries, and thus the sender and receiver country may dictate which payment provider(s) are available. Additionally, certain payment processors may have certain minimums/maximums, and the homogenization system/digital gateway 802 may determine the available payment providers based on the amounts of the requested transfer and currencies. Moreover, as discussed above, the homogenization system/digital gateway 802 may select one or more optimal payment providers based on a set of selection criteria (e.g., business rules) implemented by the homogenization system/digital gateway 802. In certain embodiments, optimal payment providers may correspond to the least cost provider, fastest provider, and/or provider with the highest likelihood of a completing the transfer successfully. The business rules for selecting optimal payment providers may be based on various factors, for example, the countries of the sender and receiver, the requested transfer amount, the requested currency types for the transfer, individual sender and receiver data (e.g., demographics, addresses, risk scores, etc.), contract minimums with different payment providers, decline rates of different payment providers, multivariate testing, DBA, merchant descriptors, etc. After determining the set of available and/or optimal payment providers in step 1202, the homogenization system/digital gateway 802 may transmit the set back to the website, mobile application, or other frontend system, to allow the customer to select a payment provider and initiate the money transfer.

In step 1203, the customer has interacted further with the website, mobile application, or other frontend system to select a payment type and payment information for the requested money transfer. The homogenization system/digital gateway 802 may receive this data in step 1203, and access the determined processor(s) to validate the payment information in step 1204. After successfully validating the payment information in step 1204, the homogenization system/digital gateway 802 may transmit a confirmation that the payment information is valid back to the front-end system 820, and the front-end system 820 may then initiate one more core system processes 831-833 to perform the requested money transfer.

In step 1205, the homogenization system/digital gateway 802 may receive money transfer request data from one or more core system processes 830, and in step 1206 may access the appropriate payment processor to initiate the money transfer. In step 1207, the homogenization system/digital gateway 802 may receive a confirmation from the payment processor that the payment transaction was performed successfully. In response, the homogenization system/digital gateway 802 may extract the relevant payment and confirmation data, and may generate a normalized data file/record or other notification to be transmitted to one or more core or backend systems of the eMerchant (e.g., financial transaction systems, reconciliation and settlement systems, chargeback systems, return/dispute systems, collections systems, etc.). In step 1208, the homogenization system/digital gateway 802 may receive a further confirmation indicating that the funds have been successfully transferred and now reside in the target account. In response, the homogenization system/digital gateway 802 may extract the relevant funds transfer and confirmation data, and may again generate a normalized data record or other notification to be transmitted to one or more core or backend systems of the eMerchant (e.g., financial transaction systems, reconciliation and settlement systems, chargeback systems, return/dispute systems, collections systems, etc.).

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A digital gateway comprising one or more computer servers, wherein the one or more computer servers of the digital gateway comprise:
one or more network interfaces configured to communicate with a plurality of transaction processing servers;
one or more processing units, each processing unit comprising one or more processors; and
one or more memory devices respectively coupled to and readable by the one or more processing units, the memory devices storing therein one or more sets of instructions which, when executed by the processing units, causes one or more computer servers of the digital gateway to:
receive data from a first client device, the data identifying a transaction request initiated by the first client device;
determine a first transaction processor out of a plurality of transaction processors to process the transaction request, based on the data received from the first client device;
transmit one or more authorization messages to a first transaction processing server associated with the first transaction processor, the authorization messages including instructions to initiate an authorization process for the transaction request;
initiate one or more analyses on the transaction request, wherein the analyses are performed concurrently with the authorization process for the transaction request by the first transaction processing server;
determine a capture time for the transaction request, based on results from the one or more analyses performed on the transaction request;
transmit one or more process messages to the first transaction processing server at the capture time determined for the transaction request, the process messages including instructions to the process the transaction request using the first transaction processor;
determine a dispatch time for the transaction request, based on the results from the one or more analyses performed on the transaction request; and
transmit a dispatch message to one or more output systems, the dispatch message including instructions to make output values in accordance with the transaction request accessible to one or more client devices.

2. The digital gateway of claim 1, wherein the data received from the first client device includes at least a transaction amount, one or more geographic locations associated with the transaction request, and a payment type associated with the transaction request, and
wherein the first transaction processor is selected from the plurality of transaction processors to process the transaction request, based on the data received from the first client device.

3. The digital gateway of claim 1, wherein the memory devices of the digital gateway store additional sets of instructions which, when executed by the processing units, causes one or more computer servers of the digital gateway to:
receive an authorization response from the first transaction processing server, the authorization response indicating whether or not the transaction request is authorized to be processed by the first transaction processor.

4. The digital gateway of claim 3, wherein the capture time for the transaction request is determined before receiving the authorization response from the first transaction processing server.

5. The digital gateway of claim 3, wherein the dispatch time for the transaction request is determined before receiving the authorization response from the first transaction processing server.

6. The digital gateway of claim 1, wherein the memory devices of the digital gateway store additional sets of instructions which, when executed by the processing units, causes one or more computer servers of the digital gateway to:
receive second data from a second client device, the second data identifying a second transaction request initiated by the second client device, wherein the data received from the first client device includes a first payment type associated with the transaction request, and the second data received from the second client device includes a second different payment type associated with the second transaction request; and
transmit additional authorization messages, additional process messages, and additional dispatch messages, based on the second transaction request, wherein a same set of application programming interface calls are used to transmit messages based on the transaction request and to transmit messages based on the second transaction request.

7. The digital gateway of claim 1, wherein the data received from the first client device includes a first payment type associated with the transaction request, wherein the data received from the first client device does not identify a particular transaction processor, and wherein the transaction request is processed without identifying the first transaction processor to the first client device.

8. The digital gateway of claim 1, wherein the authorization messages transmitted to the first transaction processing server, the process messages transmitted to the first transaction processing server, and the dispatch message transmitted to the one or more output systems, are event-based messages associated with the transaction request only, and are not batch messages associated with other transaction requests.

9. A method comprising:
receiving, by a transaction computer server, from an integrated software component executing within a host software application on a transaction client device, transaction sender data and transaction receiver data;
receiving, by a digital gateway server and from a first client device, data identifying a transaction request initiated by the first client device;
determining, by the digital gateway server, a first transaction processor out of a plurality of transaction processors to process the transaction request, based on the data received from the first client device;
transmitting, by the digital gateway server, one or more authorization messages to a first transaction processing server associated with the first transaction processor, the authorization messages including instructions to initiate an authorization process for the transaction request;
initiating, by the digital gateway server, one or more analyses on the transaction request, wherein the analyses are performed concurrently with the authorization process for the transaction request by the first transaction processing server;
determining, by the digital gateway server, a capture time for the transaction request, based on results from the one or more analyses performed on the transaction request;
transmitting, by the digital gateway server, one or more process messages to the first transaction processing server at the capture time determined for the transaction request, the process messages including instructions to the process the transaction request using the first transaction processor;
determining, by the digital gateway server, a dispatch time for the transaction request, based on the results from the one or more analyses performed on the transaction request; and
transmitting, by the digital gateway server, a dispatch message to one or more output systems, the dispatch message including instructions to make output values in accordance with the transaction request accessible to one or more client devices.

10. The method of claim 9, wherein the data received from the first client device includes at least a transaction amount, one or more geographic locations associated with the transaction request, and a payment type associated with the transaction request, and
wherein the first transaction processor is selected from the plurality of transaction processors to process the transaction request, based on the data received from the first client device.

11. The method of claim 9, further comprising:
receiving, by the digital gateway server, an authorization response from the first transaction processing server, the authorization response indicating whether or not the transaction request is authorized to be processed by the first transaction processor.

12. The method of claim 11, wherein the capture time for the transaction request is determined before receiving the authorization response from the first transaction processing server.

13. The method of claim 11, wherein the dispatch time for the transaction request is determined before receiving the authorization response from the first transaction processing server.

14. The method of claim 9, further comprising:
receiving, by the digital gateway server and from a second client device, second data identifying a second transaction request initiated by the second client device, wherein the data received from the first client device includes a first payment type associated with the transaction request, and the second data received from the second client device includes a second different payment type associated with the second transaction request; and
transmitting, by the digital gateway server, additional authorization messages, additional process messages, and additional dispatch messages, based on the second transaction request, wherein a same set of application programming interface calls are used to transmit messages based on the transaction request and to transmit messages based on the second transaction request.

15. The method of claim 9, wherein the data received from the first client device includes a first payment type associated with the transaction request, wherein the data received from the first client device does not identify a particular transaction processor, and wherein the transaction request is processed without identifying the first transaction processor to the first client device.

16. The method of claim 9, wherein the authorization messages transmitted to the first transaction processing server, the process messages transmitted to the first transaction processing server, and the dispatch message transmitted to the one or more output systems, are event-based messages associated with the transaction request only, and are not batch messages associated with other transaction requests.

17. A non-transitory computer readable medium storing computer-executable instructions that are executable by one or more processors, the computer-executable instructions comprising:
receiving from an integrated software component executing within a host software application on a transaction client device, transaction sender data and transaction receiver data;
receiving, from a first client device, data identifying a transaction request initiated by the first client device;
determining, a first transaction processor out of a plurality of transaction processors to process the transaction request, based on the data received from the first client device;
transmitting, one or more authorization messages to a first transaction processing server associated with the first transaction processor, the authorization messages including instructions to initiate an authorization process for the transaction request;
initiating, one or more analyses on the transaction request, wherein the analyses are performed concurrently with the authorization process for the transaction request by the first transaction processing server;
determining, a capture time for the transaction request, based on results from the one or more analyses performed on the transaction request;
transmitting, one or more process messages to the first transaction processing server at the capture time determined for the transaction request, the process messages including instructions to the process the transaction request using the first transaction processor;
determining, a dispatch time for the transaction request, based on the results from the one or more analyses performed on the transaction request; and
transmitting, a dispatch message to one or more output systems, the dispatch message including instructions to make output values in accordance with the transaction request accessible to one or more client devices.

18. The non-transitory computer readable medium of claim 17, wherein the data received from the first client device includes at least a transaction amount, one or more geographic locations associated with the transaction request, and a payment type associated with the transaction request, and
wherein the first transaction processor is selected from the plurality of transaction processors to process the transaction request, based on the data received from the first client device.

19. The non-transitory computer readable medium of claim 17, the computer-executable instructions further comprising:
receiving, by the digital gateway server, an authorization response from the first transaction processing server, the authorization response indicating whether or not the transaction request is authorized to be processed by the first transaction processor.

20. The non-transitory computer readable medium of claim 19, wherein the capture time for the transaction request is determined before receiving the authorization response from the first transaction processing server, and wherein the dispatch time for the transaction request is determined before receiving the authorization response from the first transaction processing server.
